(19) United States
(12) Patent Application Publication
(10) Pub. No.: US 2006/0055982 A1
(43) Pub. Date: Mar. 16, 2006

(54) Watermarking film prints

(76) Inventor: Gerardus Cornelis Petrus Lokhoff, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,976

(22) PCT Filed: Dec. 8, 2003
(86) PCT No.: PCT/IB03/06350

§ 371 Date: Jul. 11, 2005

(30) Foreign Application Priority Data
Jan. 14, 2003 (EP) 03075111.9

(51) Int. Cl. H04N 1/40

(52) U.S. Cl. 358/3.28

(57) ABSTRACT

The present invention relates to adding watermark information to film prints. This performed when duplicating an original film print (405) to an undeveloped copy film (407), where a surface of the original film print is positioned close to a surface of the undeveloped film. The surface of the undeveloped film is exposed with light transferred through the surface of the original film print. The watermark is obtained from a number of individually controllable light sources (411), such that the light transferred through the surface of the original film print (405) has a predefined pattern depending on how the light from the light source (409) is controlled. The invention further relates to a storage medium comprising instructions for performing the method of adding watermark information, a system for adding watermark information and a system for determining the legality of a film print copy.

### FIELD OF THE INVENTION

The present invention relates to a method of adding watermark information when duplicating an original film print to an undeveloped copy film, where a surface of the original film print is positioned close to a surface of the undeveloped film and where the surface of the undeveloped film is exposed with light transferred through the surface of the original film print. The invention also relates to a storage medium comprising instructions for performing the method of adding watermark information. Further, the invention relates to a system for adding watermark information and a system for determining the legality of a film print copy.

### BACKGROUND OF THE INVENTION

Watermarking is one of the most promising techniques for protecting the content owner's rights. Generally, watermarking is a process of altering the content such that its perceptual characteristics are preserved. More specifically, a “watermark” is a pattern inserted into the content that may be used to identify the content owners and/or the protected rights.

Watermarks are designed to be completely invisible or, more precisely, to be imperceptible to humans and statistical analysis tools. Ideally, a watermarked content is perceptually identical to the original content.

A watermark embedder (i.e., encoder) embeds a watermark into the content. It typically uses a secret key to embed the watermark. A watermark detector (i.e., decoder) extracts the watermark from the watermarked content.

To detect the watermark, some watermarking techniques require access to the original unmarked digital video or to a pristine specimen of the marked digital video. Some watermarking techniques are “blind.” This means that they do not require access to the original unmarked digital video or to a pristine specimen of the marked digital video. Of course, these “blind” watermarking techniques are desirable when the watermark detector is publicly available.

Before detection, a watermarked signal may undergo many possible changes by users and by the distribution environment. These changes may include unintentional modifications, such as noise and distortions. Moreover, the marked signal is often the subject of malicious attacks particularly aimed at disabling the detection of the watermark.

Watermarking technology has several highly desirable goals to facilitate protection of content publishers. Below are listed several of such goals.
Perceptual Invisibility—The embedded information should not induce perceptual changes in the content quality of the resulting watermarked content. The test of perceptual invisibility is often called the “golden eyes and ears” test.
Statistical Invisibility—The embedded information should be quantitatively imperceptive for any exhaustive, heuristic, or probabilistic attempt to detect or remove the watermark. The complexity of successfully launching such attacks should be well beyond the computation power of publicly available computer systems. Herein, statistical invisibility is expressly included within perceptual invisibility.
Tamperproof—An attempt to remove the watermark should damage both the value of the content and the perceptual threshold.
Cost—The system should be inexpensive to license and implement on both programmable and application-specific platforms.
Non-disclosure of the Original—The watermarking and detection protocols should be such that the process of proving content copyright both in-situ and in-court, does not involve usage of the original recording.
Enforceability and Flexibility—The watermarking technique should provide strong and undeniable copyright proof. Similarly, it should enable a spectrum of protection levels, which correspond to variable video presentations and compression standards.
Resilience to Common Attacks—Public availability of powerful content editing tools imposes that the watermarking and detection process are resilient to attacks spawned from such consoles.
Hard-to-Break—A watermark is “hard-to-break” when it is “extremely hard” for an attacker to break the watermark even though the attacker may know watermarking technique. Here, “breaking” refers to successfully modifying or removing the watermark. In particular, it should be nearly impossible to break the mark under almost all practical situations even if an attacker has a supercomputer.

Recently a number of watermarking techniques have been described for both digital video and audio content. In the field of film prints of the type being used on projection devices in e.g. cinemas or used on film laboratory equipment. It would be of interest to find a method of performing forensic protection of these film prints by using watermarks.

### OBJECT AND SUMMARY OF THE INVENTION

It is an object of the present invention to provide a solution for protecting content on film prints by using watermarks.

This is obtained by a method of adding watermark information when duplicating an original film print to an undeveloped copy film, where a surface of the original film print is positioned close to a surface of the undeveloped film and where the surface of the undeveloped film is exposed with light transferred through the surface of the original film print. The light is obtained from a controllable light source, said light source being controlled such that the light transferred through the surface of the original film print is a predefined pattern.

Thereby both a film copy and a watermark are transferred to the copy film. This results in a minor distortion of the image which is almost unnoticeable by the human eye. The control can be based on controlling the controllable light source by changing intensity and/or colour of the light source as a function of time. In that case, the mean luminance of image flames is modulated in accordance with a temporal watermark pattern. The control can also be based on controlling the controllable light source by changing the intensity and/or colour of an array of light sources. In that case, the film print will be provided with a spatial watermark pattern. The predefined pattern can afterwards be detected by a light detector comparing the detected pattern with a reference pattern.

Alternatively, it could also be the sound information on the film print which is modified with a watermark. A again the modification should result in a minor distortion of the sound which is almost unnoticeable by the human ear. The pattern could also comprise additional information such as information for time control purposes or just additional specific film information.

In an embodiment the light source is controlled by switching the light from a number of individual light sources on and off according to said predefined pattern. This is an easy way of generating and controlling a pattern, but in specific cases it would require an extra light source to ensure that the whole original film print is exposed and transferred to the copy film.

In another embodiment at least one individually controlled light source is controlled by changing the color of the light from the light source according to said predefined pattern. Thereby a large number of patterns can be generated and further no additional light source is required as mentioned above.

In yet another embodiment the individually controlled light sources are controlled by changing the intensity of the light from the light source according to said predefined pattern. Again this introduces possibilities of generating a large number of patterns since intensity can be divided into many intervals. Combined with color variations an even larger number of patterns can be obtained. The number of patterns is of importance since unique watermarks could then be generated for each original film. Further, this makes it possible to incorporate a larger amount of information in the watermarks.

In a specific embodiment, individually controlling the light sources comprises detecting the pattern of light from said light sources, comparing the detected pattern with the predefined pattern and controlling the light sources according to the difference between the detected pattern and the predefined pattern.

The feedback loop ensures that the correct and expected watermark is added to the copy film. This is important since the properties of each light source e.g. LED may vary slightly. Two different LED's might need a different control signal to provide the same color and intensity. This difference is typically because of differences when being manufactured.

The invention also relates to a computer readable medium having stored therein instructions for causing a processing unit to execute the method described above.

The invention also relates to a system for adding watermark information when duplicating an original film print to an undeveloped copy film. The system is arranged for positioning a surface of the original film print close to a surface of the undeveloped film. The system is also arranged for exposing the surface of the undeveloped film with light from a light source, said light source being positioned above the surface of the original film print whereby the light from the light source is transferred through the surface of the original film print. The arrangement comprises a controller for individually controlling the light from at least one of said light sources individually according to a predefined pattern.

In a specific embodiment the controller comprises a feedback loop comprising:
a detector for detecting the pattern from the light sources,
a comparison device comparing the detected pattern with the predefined pattern and controlling the light from the light sources according to the difference between the detected pattern and the predefined pattern.

In another embodiment the system comprises:
means for detecting a pattern, where the pattern has been added by exposing undeveloped copy film using a light source for exposing the undeveloped film through the original film print according to a pattern,
means for comparing the detected pattern with a predefined pattern,
means for determining the legality according to the difference between the detected pattern and the predefined pattern.

The advantages of the system are similar to the advantages described above in connection with the similar method claims.

### BRIEF DESCRIPTION OF THE DRAWINGS

In the following preferred embodiments of the invention will be described referring to the figures, where

FIG. 1 illustrates a system for adding a watermark pattern to a film print,

FIG. 2a-2c illustrate different embodiments of the light source, where the light sources which can be individually controlled are varied,

FIG. 3a-3b illustrate different embodiments of the light source, where the number and size of the individual light sources are varied,

FIG. 4 is an illustration of a system for adding a watermark pattern to a film print having a light detector and a feedback connection,

FIG. 5 is an illustration of a control loop for the system in FIG. 4,

FIG. 6 illustrates a detector for detecting a watermark pattern in a copy film print.

### DESCRIPTION OF PREFERRED EMBODIMENTS

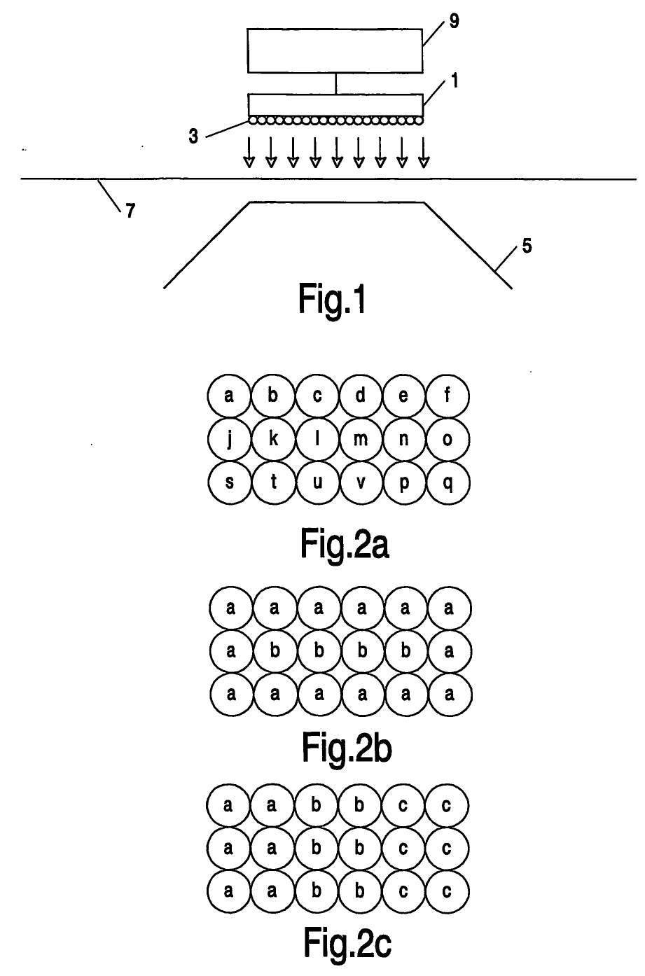

FIG. 1 illustrates a system for adding watermarks to film prints. The system comprises the light source 1 which consists of a number of individually controllable light sources 3 such as LEDs (light emitting diodes). The light source 1 is adapted to be positioned above the copy film 5 which then can be exposed to light from the light source 1 through an original film 7. The individually controllable light sources 3 are controlled from a power driver 9. The power driver 9 is connected to the light source 9 and supplies each of the individually controllable light sources 3 according to a predefined power reference which is determined based on a watermark reference.

In FIG. 2a-2c the individually controllable light is illustrated seen from the bottom. In the illustrated embodiment the light source comprises an array of 18 individually light sources. In the figures, light sources having the same letter are controlled in the same way. In FIG. 2a all light sources are controlled individually, since no light source are marked with the same letter. In FIG. 2b, the array comprises two sets of light sources where each set is individually controlled. The first set of light sources is marked with the letter a and the second set of light sources are marked with the letter b. Further in 2c an example is shown where the array comprises three sets where each set are individually controlled. Here the first set is marked with the letter a, the second set is marked with the letter b and the third set is marked with the letter c.

The light sources can be controlled individually both according to color and according to intensity, whereby a large number of different patterns can be generated. Further the number of individual light sources comprised in the light source can be varied which then together with varying the diameter of the individual light sources can be used to change the watermark pattern to have either a coarse or a fine pattern.

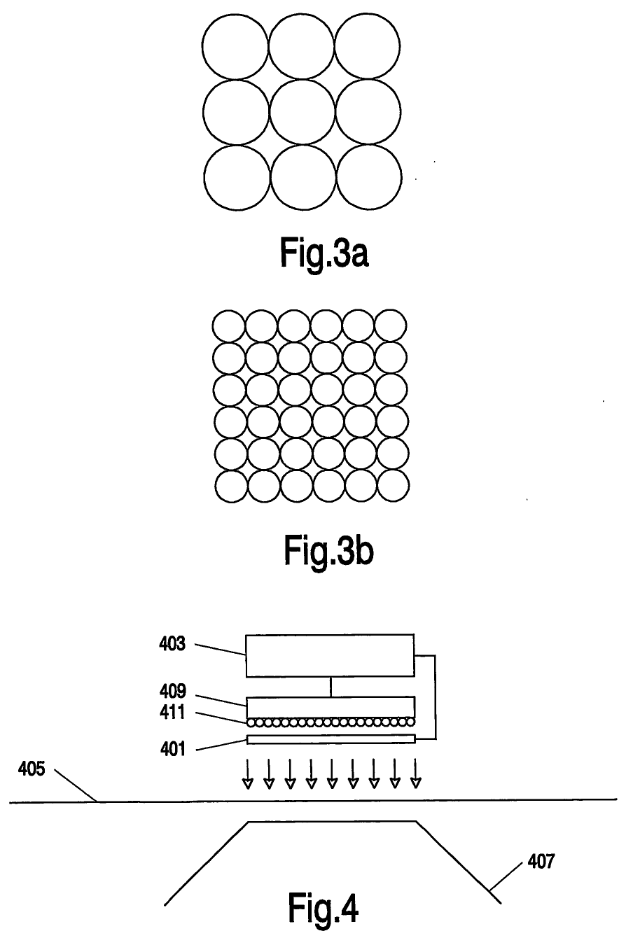

In FIG. 3a-3b, different numbers and sizes of the individual light sources are illustrated. In FIG. 3a few light sources are used resulting in a very coarse watermark pattern, which is also simpler to control and detect. In FIG. 3b a large number of individual light sources are used resulting in a fine pattern resulting in larger number of possible patterns and in a more complex detection making it more difficult for pirates to obtain.

In FIG. 4 an example is shown of a system comprising a feedback detector. The system comprises the light source 409 which consists of a number of individually controllable light sources 411 such as LEDs (light emitting diodes). The light source 409 is adapted to be positioned above the copy film 407 which can then be exposed to light from the light source 409 through an original film 405. The individually controllable light sources 411 are controlled from a power driver 403. The power driver 403 is connected to the light source 409 and supplies each of the individually controllable light sources 411 according to a predefined power reference which is determined based on a watermark reference. The system further comprises a sensor 401 for detecting intensity and color of each individual light source 411; the sensor 401 is positioned between the light source 409 and the original film 405. The sensor 401 is electronically connected to the power driver 403, whereby a difference between the detected light and the intended light, based on a reference watermark pattern, can be used to adjust the light from the relevant light sources according to either color or intensity.

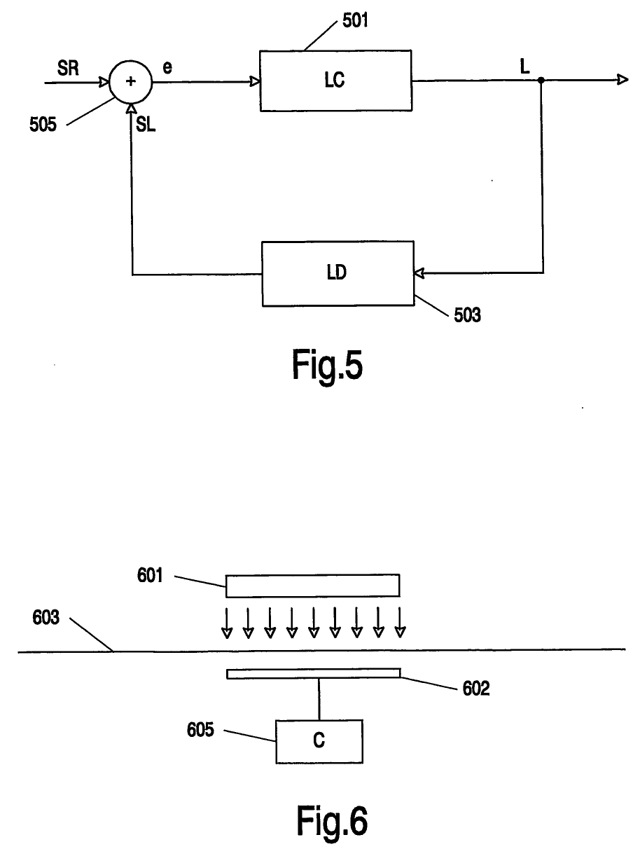

In FIG. 5 a control loop is illustrated for the system in FIG. 4. The control loop consists of a block 501 for light control LC having an error signal e as input and the light L as output. Further a block 503 has the light from each individual light source as input and a signal SL representing the light as output. In the summation 505 the actual light represented by the signal SL is compared to a signal representing the reference light RL and an error e is determined. This error can then be used as input to the light control ensuring that the reference pattern is really the pattern delivered by the light source.

In FIG. 6 a detector for detecting a watermark pattern in a copy film print is illustrated. The detector comprises a standard film print light source 601 placed above the copy film print 603 and a sensor 602 placed below the film print. The sensor 601 is adapted to detect light at predefined positions and could e.g. be similar to the sensor used in the feedback in the system of FIG. 4. The comparator 605 compares the detected light with a predefined light pattern key which e.g. could be supplied to the comparator from the user or which could be incorporated in the hardware of the comparator. Based on the difference between detected light and the suspected light or legal light defined by the pattern key it can be determined whether the copy is legal or illegal. The detector could e.g. be connected to the film viewing equipment and interrupt the playback of the copy film.

The present invention relates to adding watermark information to film prints. This is performed when duplicating an original film print (405) to an undeveloped copy film (407), where a surface of the original film print is positioned close to a surface of the undeveloped film. The surface of the undeveloped film is exposed with light transferred through the surface of the original film print. The watermark is obtained from a number of individually controllable light sources (411), such that the light transferred through the surface of the original film print (405) has a predefined pattern depending on how the light from the light source (409) is controlled. The invention further relates to a storage medium comprising instructions for performing the method of adding watermark information, a system for adding watermark information and a system for determining the legality of a film print copy.

1. A method of adding watermark information when duplicating an original film print to an undeveloped copy film, where a surface of the original film print is positioned close to a surface of the undeveloped film and where the surface of the undeveloped film is exposed with light transferred through the surface of the original film print, characterized in that said light is obtained from a controllable light source, where said light source is controlled such that the light transferred through the surface of the original film print is a predefined pattern.

2. A method according to claim 1, where the light source is controlled by switching the light from a number of individual light sources on and off according to said predefined pattern.

3. A method according to claim 1, where the light source is controlled by changing the color of the light from a number of individual light sources according to said predefined pattern.

4. A method according to claim 1, where the light source is controlled by changing the intensity of the light from a number of individual light sources according to said predefined pattern.

5. A method according to claim 1, where controlling the light source comprises
detecting the pattern of light from said light source,
comparing the detected pattern with the predefined pattern and controlling the light sources according to the difference between the detected pattern and the predefined pattern.

6. A computer readable medium having stored therein instructions for causing a processing unit to execute the method of claim 1.

7. A system for adding watermark information when duplicating an original film print to an undeveloped copy film, the system being arranged for positioning a surface of the original film print close to a surface of the undeveloped film, the system being arranged for exposing the surface of the undeveloped film with light from a light source, said light source being positioned above the surface of the original film print whereby the light from the light source is transferred through the surface of the original film print, characterized in that said arrangement comprises a controller for controlling the light from said light source according to a predefined pattern.

8. A system according to claim 7, wherein the controller comprises a feedback loop comprising:
a detector for detecting the pattern from the light sources,
a comparison device comparing the detected pattern with the predefined pattern and controlling the light from the light sources according to the difference between the detected pattern and the predefined pattern.

9. A system for determining the legality of a film print copy characterized in, that the system comprises:
means for detecting a pattern, where the pattern has been added by exposing undeveloped copy film using a light source for exposing the undeveloped film through the original film print according to a pattern,
means for comparing the detected pattern with a predefined pattern,
means for determining the legality according to the difference between the detected pattern and the predefined pattern.
